(19) United States
(12) Patent Application Publication
(10) Pub. No.: US 2006/0225338 A1
(43) Pub. Date: Oct. 12, 2006

(54) Insect trap

(76) Inventors: Jonathan Mursic, Bowmanville (CA); Pamela Mursic, Bowmanville (CA)

Correspondence Address: Elias C. Borges;Suite 406, 555 Burnhamthorpe Road, Toronto, M9C 2Y3, CA

(21) Appl. No.: 11/395,199

(22) Filed: Apr. 3, 2006

Related U.S. Application Data
(60) Provisional application No. 60/668,588, filed on Apr. 6, 2005.

(51) Int. Cl. A01M 1/04; A01M 1/14

(52) U.S. Cl. 43/113; 43/114

(57) ABSTRACT

The present invention is an improved insect trap which attracts insects via light. The insect trap consists of a web having opposite first and second sides with an adhesive portion formed on the first side. The adhesive portion has a luminescent portion for attracting insects towards the adhesive portion. An adhesive pad is formed on the second side of the web for attaching the trap to walls, windows and the like. The trap further includes a cover releasably attached to the first side of the web, the cover being dimensioned and configured to cover over the adhesive portion. The adhesive portion may take the form of a pair of elongated adhesive strips arranged on the first side of the web and the luminescent portion may take the form of an elongated luminescent strip interposed between the adhesive strips. The cover may take the form of a dome which is dimensioned and configured to cover over the adhesive strips without touching the adhesive strips.

### CROSS REFERENCE TO RELATED APPLICATION

The present application claims priority from U.S Provisional patent application Ser. No. 60/668,588 filed Apr. 6, 2005, the entirety of which is incorporated herein by reference.

### FIELD OF THE INVENTION

The invention relates generally to insect traps of the type having adhesive strips for trapping insects.

### BACKGROUND OF THE INVENTION

Household insect pests such as flies may be controlled by adhesive traps. Adhesive strip traps are one such example. These traps generally consist of a strip of webbing upon which a viscous and tacky adhesive is applied. To draw the flies to the adhesive strip, a chemical attractant may be added to the adhesive. The flies land on the adhesive strip, where they quickly become entrapped in the viscous adhesive. After the strip has trapped a number of insect pests, the strip can be disposed of in the garbage.

While adhesive insect strips are a cheap means of controlling insect populations in a home, their usefulness is limited. Most notably, the chemical attractants used to entice the insects to alight on the stip tend to be foul smelling, making them unattractive to use inside residential properties. If the chemical attractant is not incorporated into the adhesive stip, then the strip becomes ineffective at controlling the insect pest because the insects do not alight on the strip. Therefore, an improved adhesive insect strip is required.

### SUMMARY OF THE INVENTION

The present invention is an adhesive insect trap which overcomes the drawbacks of the prior art by providing improved insect attraction and adhesion without the need for foul smelling chemical attractants. The invention consists of a web having a pair of parallel elongated tacky adhesive portions on one side. An elongated luminescent portion is interposed between the pair of adhesive portions and an adhesive pad is provided on the other side of the web for attaching the trap to a wall, window, window sill or the like. The trap further includes a cover which is removably attached to the web and is dimensioned and configured to cover over the adhesive portions.

The invention further includes an insect trap as described above wherein the elongated tacky adhesive portions form contiguous elongated adhesive strips of insect trapping adhesive and wherein the luminescent portion takes the form of an elongated contiguous strip of glow in the dark material.

The invention may further include an insect trap as described above wherein the cover takes the form of a dome which is releasably adhered to the web and which is dimensioned and configured to cover over the adhesive strips without touching the adhesive strips.

It is a further object of the present invention to provide an insect trap consisting of a web having opposite first and second sides wherein the first side has an elongated adhesive portion formed thereon. The adhesive portion has a luminescent portion for attracting insects towards the adhesive portion. The web also has an adhesive pad formed on the second side of the web for attaching the web to a wall or window, or the like. Furthermore, the insect trap has a removable cover attached to the web which is dimensioned and configured to cover over the adhesive portion.

### DESCRIPTION OF THE DRAWINGS

FIG. 1. is a top view of an insect trap made in accordance with the invention.

FIG. 2. is a top view of the insect trap shown in figure one with the plastic cover removed.

FIG. 3. is a cross sectional view of the insect trap shown in FIG. 1.

FIG. 4. is a perspective view of the insect trap shown in FIG. 1.

FIG. 5. is a perspective view of the insect trap shown in FIG. 2.

FIG. 6. is a front view of the insect trap shown in FIG. 1 being attached to a window.

FIG. 7. is a front view of the insect trap after being attached to a window.

FIG. 8. is a front view of the insect trap about to be attached to the window.

FIG. 9. is a partially expanded view of the insect trap shown in FIG. 7.

In the drawings like characters of reference indicate corresponding parts in the different figures.

### DETAILED DESCRIPTION OF THE INVENTION

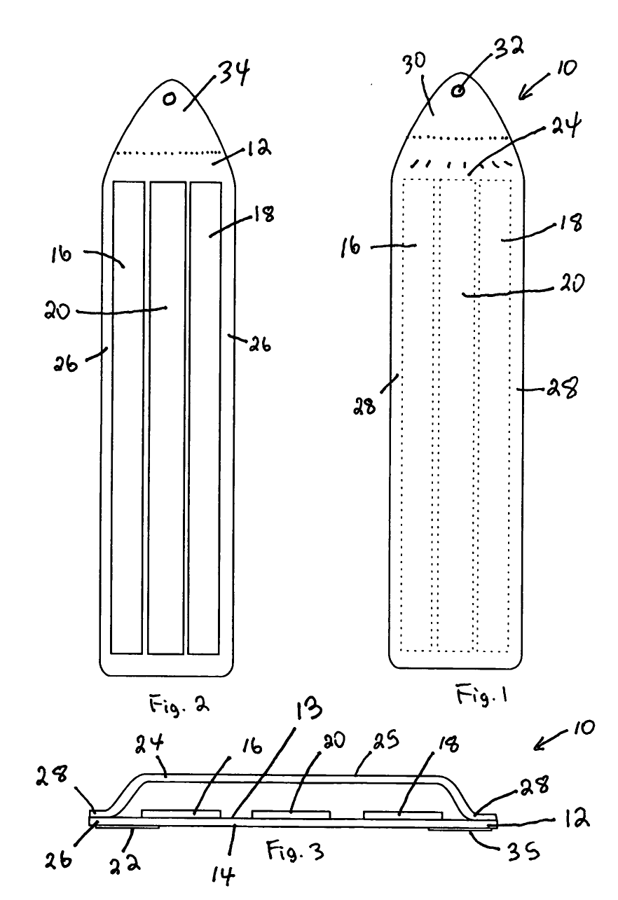

Referring firstly to FIGS. 1, 2 and 3, an insect trap made in accordance with the present invention is shown generally as item 10 consists of a web base 12 having opposite upper surface 13 and lower surface 14. Elongated adhesive layers 16 and 18 are applied to upper surface 13 on either side of central glow layer 20. The under surface 14 of web base 12 is provided with adhesive strips 22 and 35. Glow layer 20 is made of a quantity of glow in the dark material which is deposited onto surface 13 by means known generally in the art such as painting. Several glow in the dark materials are commercially available which would be suitable for this application provided the deposited material is capable of glowing in the dark for at least a few hours. Adhesive layers 16 and 18 are made from a commercially available glue which remains tacky for several days or weeks upon exposure to room air. The adhesive layers 16 and 18 are formed by depositing a viscous adhesive onto surface 13 by means known generally in the art, such as painting. The adhesive forming adhesive layers 16 and 18 must be sufficiently viscous and tacky to trap any insects which alight on the layers. The viscous adhesive currently used in manufacturing prior art insect adhesive traps (less the chemical attract) may be used in manufacturing the invention. Adhesive layers 22 and 35 are made of a different adhesive than the adhesive strips 16 and 18. The adhesive forming adhesive layers 22 and 35 is configured to permit the temporary mounting of strip 10 to a window or wall (not shown). Any suitable adhesive generally used in the manufacture of removable masking tape, adhesive packing tape or adhesive cellophane tape and the like may be used.

Web base 12 has peripheral edges 26 surrounding the adhesive strips on surface 13. A clear plastic top 24 is adhered onto web base 12 by adhesion to peripheral edges 26. Clear plastic top 24 is a dome like structure having a dome portion 25 suspended above peripheral edges 28. Peripheral edges 28 are flat and are adhered to peripheral edges 26 of web base 12 by means of an adhesive or by wrap around the web base 12 with plastic edge 26 by package design. Top 24 has a tongue portion 30 which is not adhered to web base 12. The adhesive used to adhere top 24 to web base 12 is configured to permit the user to remove the top from the web base by simply peeling the top away by grasping tongue 30 and pulling the tongue away from the web base. Preferably, this is done after web base 12 is adhered to a wall or window surface (see FIG. 7). Web base 12 has tongue portion 34. Preferably, tongue portion 34 does not have any adhesive or glow layers deposited there on, and may be used by a user to physically hold onto the web base. Aperture 32 may be formed on tongues 30 and 34 to permit the strip to be hung on an inventory hook (not shown) to assist in the retail sale of the item.

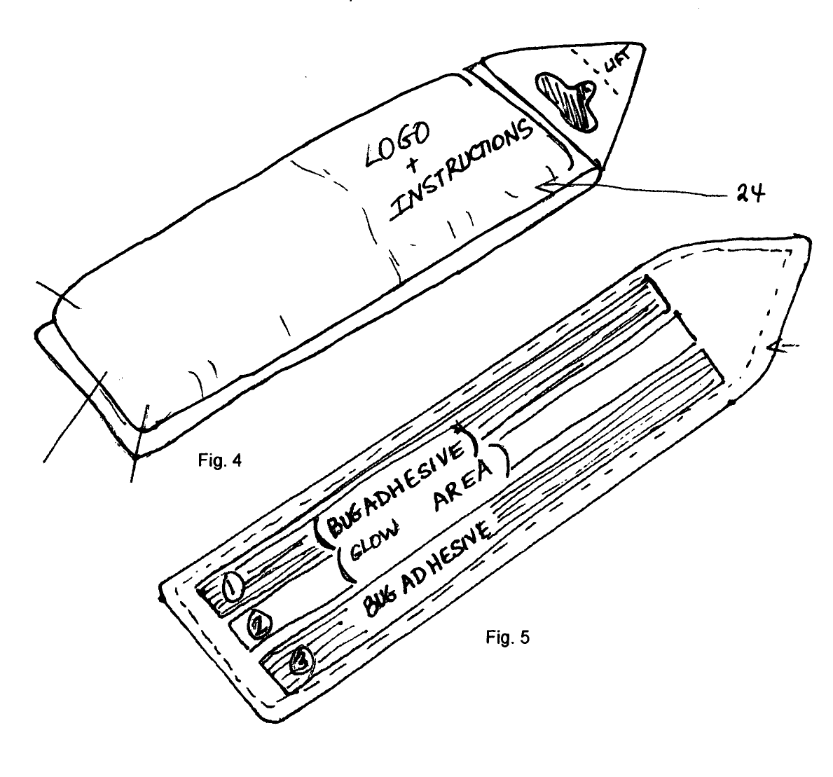

Top 24 serves to protect adhesive layers 16 and 18 and glow strip 20 while strip 10 is not in use. Top 24 may be decorated with logos, trademarks, and instructions as shown in FIGS. 4 and 5. Top 24 not only acts as a protective barrier, but also as an integral part of the packaging.

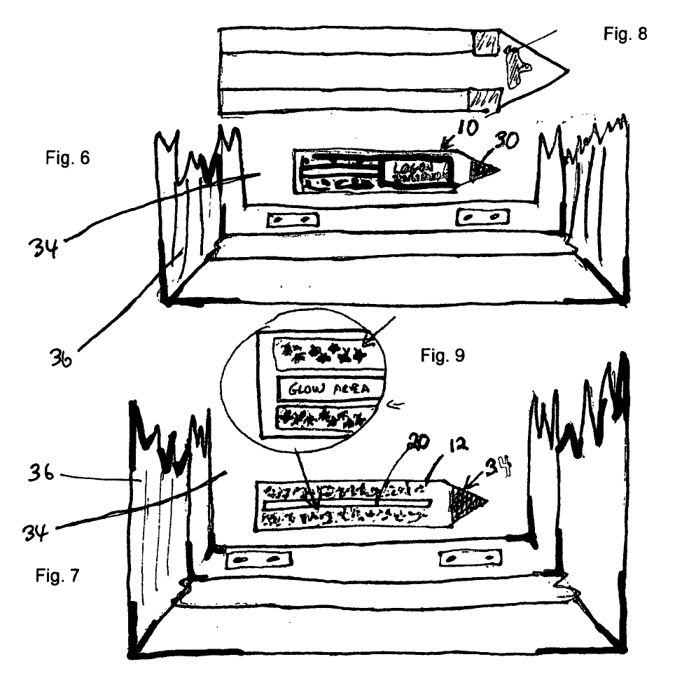

Referring now to FIGS. 6 and 7, the use of strip 10 to catch insect pests will now be described. Firstly, strip 10 is applied to window surface 34 or window 36 by pressing the strip to the window. The adhesive layers on the back of strip (see FIG. 3) helps to adhere the strip onto the window surface. When the strip is properly adhered to the window surface, the top portion of the strip is removed by pulling on tab 30 with sufficient force to peel the top off web base 12. The adhesive insect strips and glow strips are thus exposed. Glow strip 20 acts as an insect attractant, drawing insects such as flies towards strip 10. As the insects make their way to glow strip 20, they become entrapped in the adhesive strips surrounding the glow strip. Therefore, the strip is effective in attracting and entrapping insect pests without the use of foul smelling chemical attractants. When the strip has accumulated a quantity of insect pests, the strip may be removed from the window by simply pulling on tongue 34 with sufficient force to peel the strip off the window surface.

It will be appreciated that an elongated strip is disclosed with the glow stip and adhesive strips arranged as parallel strips; however, the adhesive strip and glow strips may be arranged in other fashions, such as concentric rings or the like. Furthermore, the web base forming the strip need not be formed as an elongated strip, but could also be formed as a square, triangular or even circular patch. Furthermore, it is possible to incorporate the adhesive strip and the glow strip into a single strip, say, by overlaying a glow strip with a transparent adhesive strip, or by incorporating a glow in the dark additive into the adhesive forming the adhesive strip.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. An adhesive insect trap for capturing insects comprising:
a web having opposite first and second sides;
a pair of elongated tacky adhesive portions arranged substantially parallel to each other along the first side of the web;
an elongated luminescent portion interposed between the pair of adhesive portions on the first side of the web;
an adhesive pad on the second side of the web, and
a cover removably attached to the web and enclosing the first side of the web and the adhesive portions thereon.

2. The adhesive insect trap of claim 1 wherein the web is an elongated strip of web material and wherein the adhesive portions are formed as a pair of contiguous elongated strips of tacky adhesive.

3. The adhesive insect trap of claim 2 wherein the luminescent portion takes the form of an elongated strip in parallel orientation with the adhesive strips.

4. The adhesive insect trap of claim 3 wherein the luminescent portion forms a contiguous luminescent strip and wherein the luminescent strip is made of a glow in the dark material.

5. The adhesive insect trap of claim 1 wherein the luminescent portion is made of a glow in the dark material.

6. The adhesive insect trap of claim 1 wherein the web is elongated and has first and second side edges and wherein the adhesive portions comprise a first and second elongated adhesive strip, the first adhesive strip being disposed adjacent the first edge of the web and the second adhesive strip being disposed adjacent the second edge of the web, the first and second adhesive strips being separated from the first and second edges of the web by first and second side portions of the web, respectively, the cover being adhered to the web at the first and second side portions.

7. The adhesive insect trap of claim 1 wherein the cover comprises a dome having edges, the dome being adhered to the web at the dome's edges, the dome being dimensioned and configured to enclose the adhesive portions without contacting them.

8. The adhesive insect trap of claim 6 wherein the cover comprises a dome having edges, the dome being adhered to the side portions of the web at the dome's edges, the dome being dimensioned and configured to enclose the adhesive portions without contacting them.

9. The adhesive insect trap of claim 8 wherein the adhesive portions are formed as a pair of contiguous elongated strips of tacky adhesive.

10. The adhesive insect trap of claim 9 wherein the luminescent portion takes the form of an elongated strip in parallel orientation with the adhesive strips.

11. The adhesive insect trap of claim 10 wherein the luminescent portion forms a contiguous luminescent strip and wherein the luminescent strip is made of a glow in the dark material.

12. The adhesive insect trap of claim 1 wherein the adhesive pad on the second side of the web is dimensioned and configured to adhere the web to a surface.

13. An adhesive insect trap for capturing insects comprising:
a web having opposite first and second sides and opposite first and second edges;
a pair of contiguous elongated tacky adhesive strips arranged substantially parallel to each other along the first side of the web;
an elongated contiguous luminescent strip interposed between the pair of adhesive strips on the first side of the web and extending along the web parallel to the adhesive strips;
an adhesive pad on the second side of the web, and
a cover removably attached to the web adjacent the side edges of the web, the cover being dimensioned and configured to substantially cover over the adhesive strips.

14. The adhesive insect trap of claim 13 wherein the cover takes the form of a dome having side edges, the dome being releasably adhered to the web at the dome's side edges.

15. The adhesive insect trap of claim 13 wherein the luminescent strip is made of a glow in the dark material and wherein the cover is transparent.

16. The adhesive insect trap of claim 14 wherein the luminescent strip is made of a glow in the dark material and wherein the cover is transparent.

17. An insect trap comprising:
a web having opposite first and second sides;
an adhesive portion formed on the first side of the web;
the adhesive portion having a luminescent portion for attracting insects towards the adhesive portion;
an adhesive pad formed on the second side of the web, and a cover releasably attached to the first side of the web, the cover being dimensioned and configured to cover over the adhesive portion.

18. The insect trap of claim 17 wherein the adhesive portion comprises a pair of elongated adhesive strips arranged on the first side of the web and wherein the luminescent portion comprises an elongated luminescent strip interposed between the adhesive strips.

19. The insect trap of claim 18 wherein the adhesive strips and luminescent strips are arranged in parallel.

20. The insect trap of claim 19 wherein the cover comprises a dome dimensioned and configured to cover over the adhesive strips without touching them.
